(19) United States
(12) Patent Application Publication
(10) Pub. No.: US 2016/0334666 A1
(43) Pub. Date: Nov. 17, 2016

(54) LCD HEATING CONTROL SYSTEM AND METHOD THEREOF

(71) Applicant: LITEMAX ELECTRONICS INC., New Taipei City (TW)

(72) Inventor: CHIN-CHEN LIU, NEW TAIPEI CITY (TW)

(21) Appl. No.: 14/712,936

(22) Filed: May 15, 2015

(51) Int. Cl. G02F 1/1333; G01K 13/00

(52) U.S. Cl. CPC G02F 1/133382; G01K 13/00

(57) ABSTRACT

A LCD heating control system and method enable a backlight module in a LCD to heat a LCD panel in the LCD. The LCD heating control system includes a heat-conducting element and a micro control temperature sensing circuit. The micro control temperature sensing circuit determines whether the sensed LCD temperature meets a heating requirement and, when the determination is affirmative, enables the backlight module to operate at a high power mode and heat to be transferred from the backlight module to the LCD panel through the heat-conducting element.

### FIELD OF TECHNOLOGY

The present invention relates to heating systems and methods, and more particularly, to a LCD heating system and method, wherein the system comprises a backlight module for generating heat to heat up liquid crystal molecules and thus is fit to substitute for conventional LCD heating systems.

### BACKGROUND

Liquid crystal displays (LCDs) are common display apparatuses. Due to their advantages, such as compactness and low power consumption, LCDs are substituting for conventional cathode ray tube (CRT) monitors and thus have become the commonest image display apparatuses for use in electronic industry and information industry nowadays.

A conventional LCD usually comprises a LCD panel and a backlight module. The backlight module comprises a light source and a light guiding plate. The light source corresponds in position to the light guiding plate. Light rays emitted from the light source are guided by the light guiding plate to the LCD panel. By controlling the arrangement of liquid crystal molecules in the LCD panel, it is practicable to change the angle of incidence of the light rays on the liquid crystal molecules to thereby switch on and off the light rays and control the display screen of the LCD. However, due to material-related limitations on the liquid crystal molecules, the LCD panel is quite sensitive to a change in ambient temperature. When the LCD is operating at a low temperature, the liquid crystal molecules have a low reaction rate; as a result, not only are ghost images likely to occur to the screen of the LCD which is playing a video, but the LCD also manifests contrast diminution and uneven color to the detriment of the quality of images displayed on the LCD. When the LCD is operating at an extremely low temperature (for example, outdoors in a cold place), say, −20° C. through −30° C., the LCD is likely to end up in liquid crystal aggregation and thus fail; as a result, to reboot the LCD, it is necessary to raise the ambient temperature.

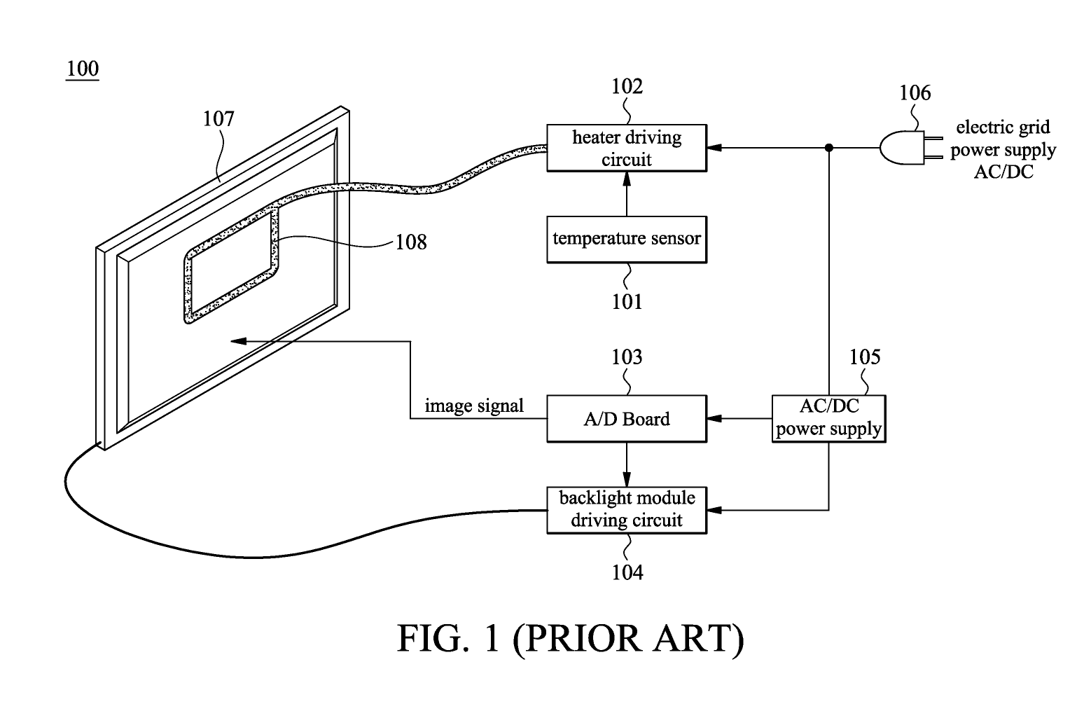

Referring to FIG. 1, a conventional LCD 100 which provides a low-temperature environment problem-solving solution comprises a heating-end circuit and an image-end circuit. The heating-end circuit comprises a plurality of heaters 108 affixed to the back of a LCD set 107, a heater driving circuit 102 coupled to the heaters, and a temperature sensor 101 coupled to the heater driving circuit 102. The temperature sensor 101 is disposed on the back of the LCD set 107 and adapted to fetch temperature-related data pertaining to the LCD set 107 and send a start signal to the heater driving circuit 102 so as to use an electric grid power supply (alternating current)106 to drive the heaters 108. When driven, the heaters 108 heat up the back of the LCD set 107 such that the temperature of the LCD set 107 rises quickly to a point at which the liquid crystals begin to operate well. The image-end circuit is independent of the heating-end circuit and comprises an image control circuit 103(A/D Board), a backlight module driving circuit 104, and an AC/DC power supply 105. The image control circuit 103 not only controls the backlight module driving circuit 104 but also sends an image signal to the LCD set 107 to keep the image-end circuit functioning.

Nonetheless, the aforesaid conventional problem-solving solution requires heaters which function as energy-converting devices provided in the form of the heating-end circuit for use in converting electrical energy into thermal energy, thereby adding to costs. In addition, during the manufacturing process of the aforesaid LCD, it is time-consuming and laborious to affix the heaters to the LCD (especially large-sized LCD). Furthermore, not only does the original backlight module require a wiring and power supply, but the heaters also consume much power and use an electric grid power supply (alternating current) as a power source, and thus the heaters require a dedicated wiring and power supply; as a result, the communication between the image-end circuit in charge of image transmission and the heating-end circuit for use in a heating process performed with the heaters is so difficult as to compromise the control exercisable over the circuit on the whole and even pose a threat to user safety, for example, being ignorant of the heating status of the heating-end circuit. the image-end circuit sends signals repeatedly.

### SUMMARY

In view of the aforesaid drawbacks of the prior art, it is an objective of the present invention to provide a backlight module for generating heat to heat up liquid crystal molecules and thus is fit to substitute for conventional LCD heating systems.

Another objective of the present invention is to integrate a heating-end circuit and an image-end circuit into a control circuit to thereby enhance the communication between the image-end circuit and the heating-end circuit.

In order to achieve the above and other objectives, the present invention provides a LCD heating control system, adapted to control a backlight module in a LCD and thereby heat a LCD panel in the LCD, the LCD heating control system comprising: a heat-conducting element for connecting the LCD panel and the backlight module so as to transfer heat from the backlight module to the LCD panel; and a micro control temperature sensing circuit disposed in the LCD to sense a temperature of the LCD, enable the backlight module to operate at a high power mode when the sensed temperature meets a predetermined heating requirement, and enable the backlight module to operate at a low power mode having a power lower than the high power mode when the sensed temperature does not meet the heating requirement.

As regards the LCD heating control system, the micro control temperature sensing circuit stops transmission of an image signal pertaining to a display frame of the LCD panel when the temperature sensed by the micro control temperature sensing circuit meets the heating requirement.

As regards the LCD heating control system, the micro control temperature sensing circuit resumes transmission of an image signal pertaining to a display frame of the LCD panel when the temperature sensed by the micro control temperature sensing circuit does not meet the heating requirement.

In order to achieve the above and other objectives, the present invention further provides a LCD capable of heating, comprising: a LCD set comprising a LCD panel, a backlight module, and a heat-conducting element for connecting the LCD panel and the backlight module so as to transfer heat from the backlight module to the LCD panel; and a micro control temperature sensing circuit disposed in the LCD set to sense a temperature of the LCD set, enable the backlight module to operate at a high power mode when the sensed temperature meets a predetermined heating requirement, and enable the backlight module to operate at a low power mode having a power lower than the high power mode when the sensed temperature does not meet the heating requirement.

According to the present invention, the LCD further comprises an image control circuit for controlling image transmission of the LCD panel, wherein the micro control temperature sensing circuit is coupled to the image control circuit such that the micro control temperature sensing circuit is informed of a present status of image transmission of the image control circuit.

As regards the LCD of the present invention, the micro control temperature sensing circuit stops transmission of an image signal pertaining to a display frame of the LCD panel when the temperature sensed by the micro control temperature sensing circuit meets the heating requirement, whereas the micro control temperature sensing circuit resumes transmission of an image signal pertaining to a display frame of the LCD panel when the temperature sensed by the micro control temperature sensing circuit does not meet the heating requirement.

In order to achieve the above and other objectives, the present invention further provides a LCD heating control method , adapted to control a backlight module in a LCD and thereby heat a LCD panel in the LCD, the LCD heating control method comprising the steps of: (a) detecting a temperature of the LCD; (b) determining whether the temperature meets a heating requirement; (c) enabling the backlight module to operate at a high power mode when the temperature of the LCD meets the heating requirement; and (d) transferring heat from the backlight module to the LCD panel.

As regards the LCD heating control method, step (c) further comprises stopping transmission of an image signal pertaining to a display frame of the LCD panel.

As regards the LCD heating control method, step (b) is followed by step (c′) of enabling the backlight module to operate at a low power mode having a power lower than the high power mode when the temperature of the LCD does not meet heating requirement.

As regards the LCD heating control method, step (c′) further comprises resuming transmission of an image signal pertaining to a display frame of the LCD panel.

In conclusion, the present invention provides the aforesaid heating control system and method for use in controlling a backlight module in a LCD to thereby heat up a LCD panel in the LCD. The LCD heating control system comprises a heat-conducting element and a micro control temperature sensing circuit. The micro control temperature sensing circuit determines whether the sensed temperature of the LCD meets a heating requirement, enables the backlight module to operate at a high power mode when the determination is affirmative, and transfers heat from the backlight module to the LCD panel through the heat-conducting element, so as to replace conventional heaters. In addition, signals and instructions are exchanged between the micro control temperature sensing circuit and the image control circuit to not only ensure the consistency in the status of the image transmission and the heating status but also enhance the controllability and safety of the circuitry in its entirety.

### BRIEF DESCRIPTION

Objectives, features, and advantages of the present invention are hereunder illustrated with specific embodiments in conjunction with the accompanying drawings, in which:

FIG. 1 (PRIOR ART) is a schematic view of a low-temperature environment problem-solving solution provided by a conventional LCD;

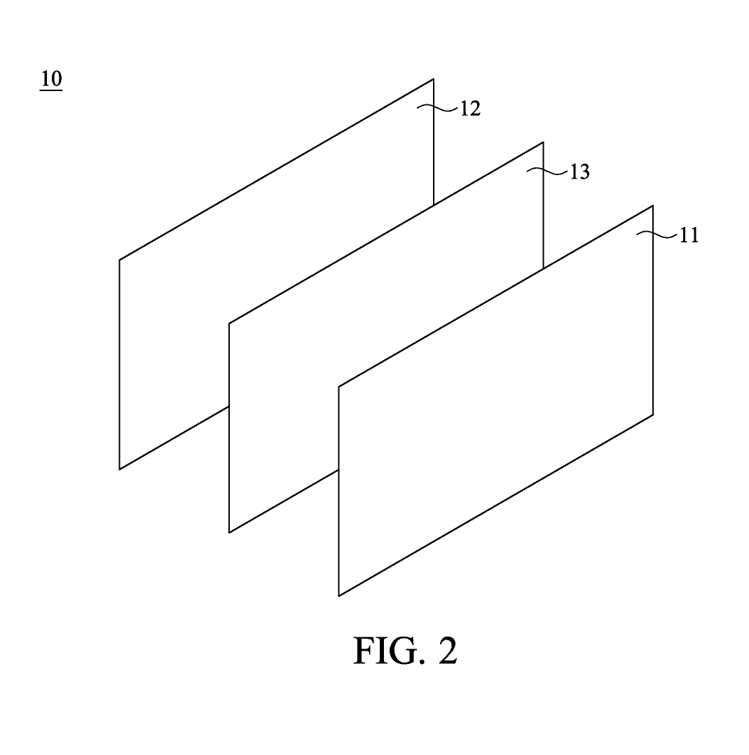

FIG. 2 is a schematic view of a LCD set according to an embodiment of the present invention;

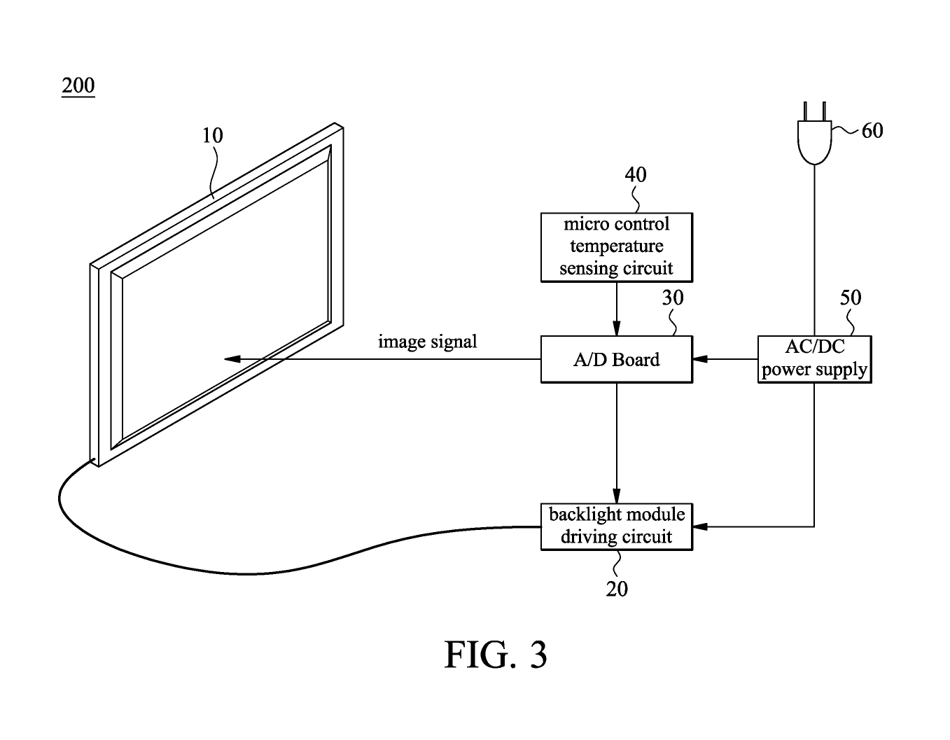

FIG. 3 is a schematic view of a LCD heating control system according to a preferred embodiment of the present invention;

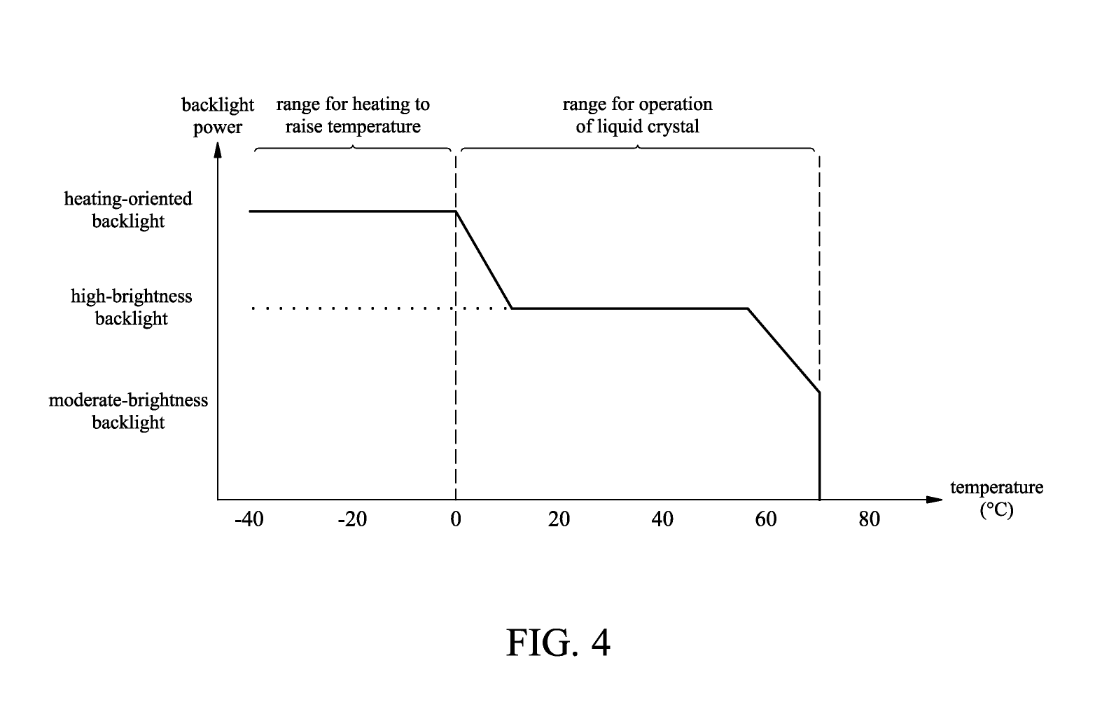

FIG. 4 is a schematic view of the control logic of the LCD heating control system according to a preferred embodiment of the present invention;

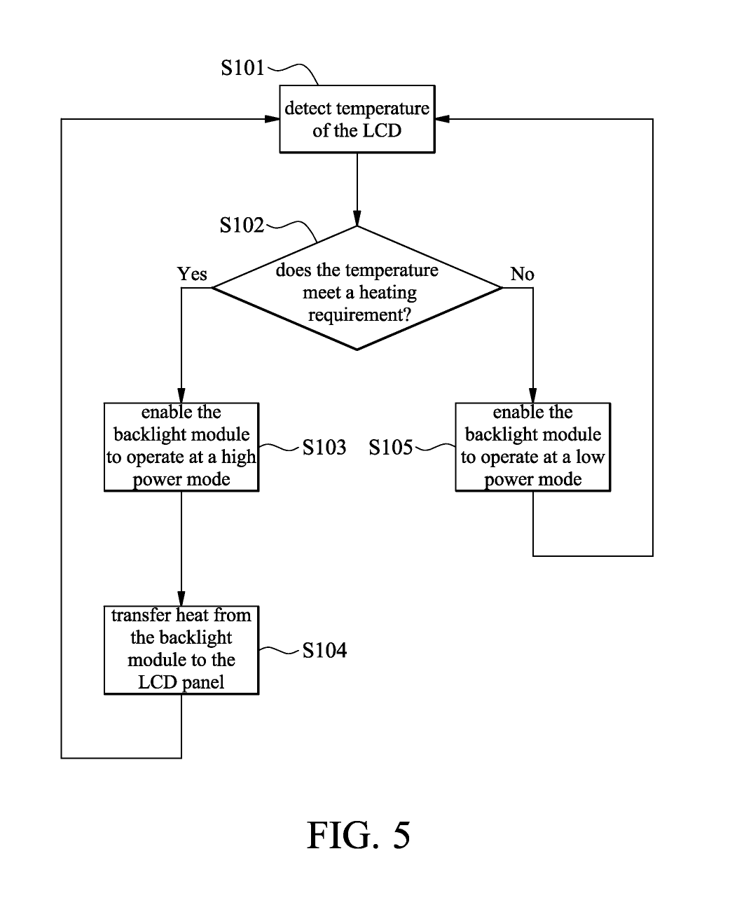

FIG. 5 is a flow chart of a LCD heating control method according to another embodiment of the present invention; and

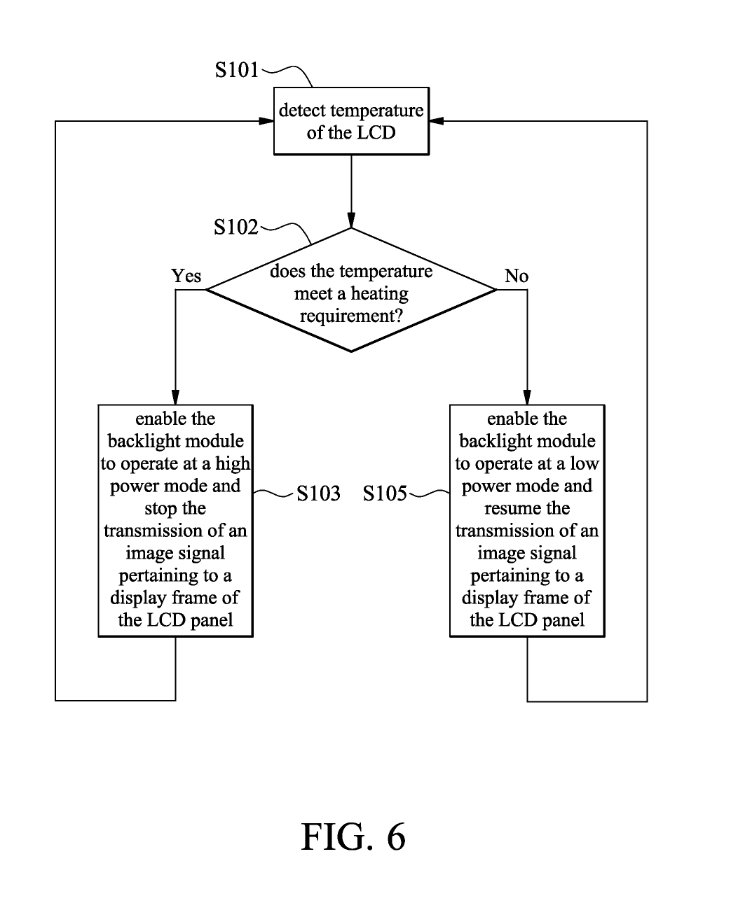

FIG. 6 is a flow chart of the LCD heating control method according to another embodiment of the present invention.

### DETAILED DESCRIPTION

FIG. 2 is a schematic view of a LCD set according to an embodiment of the present invention. FIG. 3 is a schematic view of a LCD heating control system according to a preferred embodiment of the present invention. FIG. 4 is a schematic view of the control logic of the LCD heating control system according to a preferred embodiment of the present invention. The present invention is hereunder described by making reference to FIG. 2, FIG. 3 and FIG. 4.

In this embodiment, a LCD heating control system 200 comprises a LCD set 10. Referring to FIG. 2, the LCD set 10 comprises a LCD panel 11, a backlight module 12 and a heat-conducting element 13. Since liquid crystals themselves do not emit any light, the purpose of the backlight module 12 is to provide light rays which are sufficiently bright and uniformly distributed. The heat-conducting element 13 connects the LCD panel 11 and the backlight module 12 so as to transfer heat from the backlight module 12 to the LCD panel 11 and thus heat up the LCD panel 11. Referring to FIG. 2, the heat-conducting element 13 is disposed between the LCD panel 11 and the backlight module 12, but the present invention is not limited thereto. In another embodiment, the heat-conducting element 13 is not only provided in the form of a metallic backboard and disposed behind the LCD panel 11 and the backlight module 12 but also has an extension portion which extends forward. The heat generated from the backlight module 12 is first accumulated at the heat-conducting element 13 disposed behind the backlight module 12 and then transferred by the extension portion to the LCD panel 11 disposed in front of the backlight module 12. In addition, the heat-conducting element 13 is made of a material, such as aluminum, which has high thermal conductivity, but the present invention is not limited thereto. In another embodiment, the heat-conducting element 13 is provided in the form of a portion of a casing of the LCD set 10. In conclusion, persons skilled in the art understand that a heat-conducting element serves as a means of transferring heat and thus must not be restricted to any specific structural feature, and that whatever heat-conducting element and method capable of transferring heat from the backlight module 12 to the LCD panel 11 must fall into the claims of the present invention.

Depending on the magnitude of its operating power, the backlight module 12 is defined with a plurality of backlight power levels. In this embodiment, the backlight module 12 provides three backlight power levels, namely heating-oriented backlight, high-brightness backlight, and moderate-brightness backlight, according to the magnitude of its operating power. Referring to FIG. 3, heating-oriented backlight requires a larger operating power than high-brightness backlight, whereas high-brightness backlight requires a larger operating power than moderate-brightness backlight, thereby indicating that backlight power levels are configured and adjusted as needed. In another embodiment, the backlight module 12 provides two backlight power levels or at least four backlight power levels, according to the magnitude of its operating power. In another embodiment, heating-oriented backlight, high-brightness backlight, and moderate-brightness backlight each feature a plurality of backlight power levels, for example, 350W and 400W.

The LCD heating control system 200 further comprises a backlight module driving circuit 20, an image control circuit (A/D Board)30 and a micro control temperature sensing circuit 40, each of which converts an electric grid power supply (alternating current) 60 into direct current through an AC/DC power supply 50 in order to supply power. The backlight module driving circuit 20 drives the backlight module 12 to operate. The image control circuit 30 not only sends an image signal to the LCD panel 11, but is also coupled to the backlight module driving circuit 20 and the micro control temperature sensing circuit 40. The image control circuit 30 is configured to operate selectively in two states, namely a first image transmission state and a second image transmission state. When operating in the first image transmission state, the image control circuit 30 sends an image signal to the LCD panel 11 continuously. When operating in the second image transmission state, the image control circuit 30 does not send the image signal to the LCD panel 11. When operating in the first image transmission state, the image control circuit 30 further sends an image continuous transmission signal to the micro control temperature sensing circuit 40. When operating in the second image transmission state, the image control circuit 30 sends an image transmission cessation signal to the micro control temperature sensing circuit 40. Hence, the micro control temperature sensing circuit 40 is informed of the operating status of the image control circuit 30, for example, whether the image transmission is taking place. In another embodiment, the image control circuit 30 is configured to operate selectively in three or more image transmission states in which the image control circuit 30 sends a signal indicative of its present image transmission state to the micro control temperature sensing circuit 40. In an embodiment, the micro control temperature sensing circuit 40 detects the image transmission status of the image control circuit with a control program.

In another embodiment of the present invention, the temperature of the LCD set 10 is measured with a plurality of temperature sensors (not shown) so as to fetch temperature-related data pertaining to the LCD set 10. The temperature sensors are disposed at at least one of the LCD panel 11, the backlight module 12 and the heat-conducting element 13 of the LCD set 10. At least one of the temperature sensors is disposed outside the LCD set 10 so as to fetch an ambient temperature-related data. Hence, the present invention is not restricted to detecting the temperature of the LCD set 10. In an embodiment, one of the temperature sensors is centrally disposed at the LCD panel 11.

In this embodiment, the temperature sensors together constitute a part of the micro control temperature sensing circuit 40 to detect the temperature of the LCD set 10. The micro control temperature sensing circuit 40 further determines whether the temperature of the LCD set 10 meets a heating requirement. Hence, the temperature sensors and the micro control temperature sensing circuit 40 together detect the temperature and determine whether a heating requirement is met. In another embodiment, the temperature sensors are independent of the micro control temperature sensing circuit 40 and detect the ambient temperature of the LCD set 10 to fetch the ambient temperature-related data and temperature-related data pertaining to the LCD set 10 and then transmit the ambient temperature-related data and temperature-related data pertaining to the LCD set 10 to the micro control temperature sensing circuit 40 in a wired or wireless manner. In this embodiment, the temperature sensors are in the number of one, wherein the micro control temperature sensing circuit 40 treats the temperature detected with the temperature sensor as the temperature of the LCD set 10. In another embodiment, the temperature sensors are in the number of two or more, wherein the temperature detected with any one of the temperature sensors is treated by the micro control temperature sensing circuit 40 as the temperature of the LCD set 10. In yet another embodiment, the micro control temperature sensing circuit 40 takes the average of all the temperatures detected with the temperature sensors and then treats the average temperature as the temperature of the LCD set 10.

Afterward, the micro control temperature sensing circuit 40 determines whether the temperature of the LCD set 10 meets a predetermined heating requirement. For example, the heating requirement is set to any temperature lower than 0 degree Celsius such that, after perceiving that the temperature of the LCD set 10 is lower than 0 degree Celsius, the micro control temperature sensing circuit 40 determines that the heating requirement is met, otherwise the micro control temperature sensing circuit 40 determines that the heating requirement is not met.

The heating requirement is the temperature being above an upper limit, the temperature being lower than a lower limit, or the temperature being within a temperature range.

In this embodiment, after perceiving that the temperature of the LCD set 10 is lower than 0 degree Celsius (i.e., in conformity with the heating requirement), the micro control temperature sensing circuit 40 enables the backlight module to operate at a high power mode. When operating at the high power mode, the backlight module provides heating-oriented backlight which has one of the aforesaid three backlight power levels. For example, the micro control temperature sensing circuit 40 sends a heating-oriented backlight start instruction to the image control circuit 30. Then, the image control circuit 30 sends the heating-oriented backlight start signal to the backlight module driving circuit 20 in accordance with the heating-oriented backlight start instruction such that the backlight module 12 enters a heating state. Under the heating state, the heat generated from the backlight module 12 is transferred to the LCD panel 11 through the heat-conducting element 13 such that the temperature of the LCD set 10 rises quickly until it reaches the temperature required for normal operation; hence, the LCD panel 11 can be heated up rapidly. In another embodiment, depending on product needs or consumer needs, the high power mode is one that matches any one of the aforesaid backlight power levels.

In this embodiment, after perceiving that the temperature of the LCD set 10 is not lower than 0 degree Celsius (i.e., not in conformity with the heating requirement), the micro control temperature sensing circuit 40 enables the backlight module to operate at a low power mode. The low power mode is dedicated to high-brightness backlight such that the backlight module operates at a normal power levels. For example, the micro control temperature sensing circuit 40 sends a heating-oriented backlight shutdown instruction to the image control circuit 30, and then the image control circuit 30 sends a heating-oriented backlight shutdown signal to the backlight module driving circuit 20 in accordance with the heating-oriented backlight shutdown instruction; as a result, the backlight module driving circuit 20 drives the backlight module 12 to terminate the heating state, and then the backlight module 12 cools down gradually to the high-brightness backlight level. In another embodiment, depending on product needs or consumer needs, the low power mode is dedicated to moderate-brightness backlight or any backlight power level except the highest power level.

In an embodiment, when the micro control temperature sensing circuit 40 determines that the temperature of the LCD set 10 meets a predetermined heating requirement, this indicates that the LCD set 10 is operating at the heating state and thus temporarily unavailable; meanwhile, the micro control temperature sensing circuit 40 sends an image transmission stop instruction to the image control circuit 30 to enable the image control circuit 30 to stop sending the image signal (in this embodiment, the micro control temperature sensing circuit 40 is ignorant of the present status of image transmission of the image control circuit 30.) In another embodiment, the micro control temperature sensing circuit 40 determines whether the temperature of the LCD set 10 meets a predetermined heating requirement and is informed of the present status of image transmission of the image control circuit 30. When it is determined that the temperature of the LCD set 10 meets the heating requirement and that the present status of image transmission of the image control circuit 30 is normal (i.e., the first image transmission state in one of the aforesaid embodiments), it indicates that the LCD set 10 is operating at the heating state and thus temporarily unavailable but the image control circuit 30 is presently carrying out invalid image transmission; meanwhile, the micro control temperature sensing circuit 40 sends an image transmission stop instruction to the image control circuit 30 to enable the image control circuit 30 to stop sending the image signal and enter the second image transmission state.

In an embodiment, when the micro control temperature sensing circuit 40 determines that the temperature of the LCD set 10 does not meet a predetermined heating requirement, this indicates that the LCD set 10 is not operating at the heating state and thus is temporarily available; meanwhile, the micro control temperature sensing circuit 40 sends an image transmission permitted instruction to the image control circuit 30 to permit the image control circuit 30 to begin sending the image signal (in this embodiment, the micro control temperature sensing circuit 40 is ignorant of the present status of image transmission of the image control circuit 30.) In another embodiment, the micro control temperature sensing circuit 40 determines whether the temperature of the LCD set 10 meets a predetermined heating requirement and is informed of the present status of image transmission of the image control circuit 30. When the temperature of the LCD set 10 meets the heating requirement and the image control circuit 30 stops carrying out image transmission (i.e., the second image transmission state in one of the aforesaid embodiments), this indicates that the LCD set 10 is not operating at the heating state and thus is temporarily available, but the image control circuit 30 is not carrying out any image transmission; meanwhile, the micro control temperature sensing circuit 40 sends an image transmission permitted instruction to the image control circuit 30 to permit the image control circuit 30 to begin sending the image signal. In another embodiment, the micro control temperature sensing circuit 40 sends an image transmission start instruction to the image control circuit 30 to enable the image control circuit 30 to begin sending the image signal and enter the first image transmission state.

Referring to FIG. 5 and FIG. 6, there are shown flow charts of a LCD heating control method according to another embodiment of the present invention. The process flow of the LCD heating control method comprises the steps described below.

S101: detect temperature of the LCD.

S102: determine whether the detected temperature of the LCD meets a heating requirement.

S103: enable the backlight module to operate at a high power mode and stop the transmission of an image signal pertaining to a display frame of the LCD panel when the determination is affirmative. Step S103 is followed by step S104 when the determination is affirmative but followed by step S105 when the determination is negative.

S104: transfer heat from the backlight module to the LCD panel to raise the temperature of the LCD panel. Step S104 is followed by step S101.

S105: enable the backlight module to operate at a low power mode which has less power than the high power mode and resume the transmission of an image signal pertaining to a display frame of the LCD panel.

The heating requirement is the temperature being above an upper limit, the temperature being lower than a lower limit, or the temperature being within a temperature range.

The present invention is disclosed above by preferred embodiments. However, persons skilled in the art should understand that the preferred embodiments are illustrative of the present invention only, but should not be interpreted as restrictive of the scope of the present invention. Hence, all equivalent modifications and replacements made to the aforesaid embodiments should fall within the scope of the present invention. Accordingly, the legal protection for the present invention should be defined by the appended claims.

What is claimed is:

1. A LCD heating control system, adapted to control a backlight module in a LCD and thereby heat a LCD panel in the LCD, the LCD heating control system comprising:
a heat-conducting element for connecting the LCD panel and the backlight module so as to transfer heat from the backlight module to the LCD panel; and
a micro control temperature sensing circuit disposed in the LCD to sense a temperature of the LCD, enable the backlight module to operate at a high power mode when the sensed temperature meets a predetermined heating requirement, and enable the backlight module to operate at a low power mode having a power lower than the high power mode when the sensed temperature does not meet the heating requirement.

2. The LCD heating control system of claim 1, wherein the micro control temperature sensing circuit stops transmission of an image signal pertaining to a display frame of the LCD panel when the temperature sensed by the micro control temperature sensing circuit meets the heating requirement.

3. The LCD heating control system of claim 1, wherein the micro control temperature sensing circuit stops transmission of an image signal pertaining to a display frame of the LCD panel when the temperature sensed by the micro control temperature sensing circuit meets the heating requirement.

4. A LCD capable of heating, comprising:
a LCD set comprising a LCD panel, a backlight module, and a heat-conducting element for connecting the LCD panel and the backlight module so as to transfer heat from the backlight module to the LCD panel; and
a micro control temperature sensing circuit disposed in the LCD set to sense a temperature of the LCD set, enable the backlight module to operate at a high power mode when the sensed temperature meets a predetermined heating requirement, and enable the backlight module to operate at a low power mode having a power lower than the high power mode when the sensed temperature does not meet the heating requirement.

5. The LCD of claim 4, further comprising an image control circuit for controlling image transmission of the LCD panel, wherein the micro control temperature sensing circuit is coupled to the image control circuit such that the micro control temperature sensing circuit is informed of a present status of image transmission of the image control circuit.

6. The LCD of claim 5, wherein the micro control temperature sensing circuit stops transmission of an image signal pertaining to a display frame of the LCD panel when the temperature sensed by the micro control temperature sensing circuit meets the heating requirement, wherein the micro control temperature sensing circuit resumes transmission of an image signal pertaining to a display frame of the LCD panel when the temperature sensed by the micro control temperature sensing circuit does not meet the heating requirement.

7. A LCD heating control method, adapted to control a backlight module in a LCD and thereby heat a LCD panel in the LCD, the LCD heating control method comprising the steps of:
(a) detecting a temperature of the LCD;
(b) determining whether the temperature meets a heating requirement;
(c) enabling the backlight module to operate at a high power mode when the temperature of the LCD meets the heating requirement; and
(d) transferring heat from the backlight module to the LCD panel.

8. The heating control method of claim 7, wherein step (c) further comprises stopping transmission of an image signal pertaining to a display frame of the LCD panel.

9. The heating control method of claim 7, wherein step (b) is followed by step (c′) of enabling the backlight module to operate at a low power mode having a power lower than the high power mode when the temperature of the LCD does not meet heating requirement.

10. The heating control method of claim 7, wherein step (c′) further comprises resuming transmission of an image signal pertaining to a display frame of the LCD panel.
